(19) United States
(12) Patent Application Publication
(10) Pub. No.: US 2003/0001862 A1
(43) Pub. Date: Jan. 2, 2003

(54) Method for the minimization of artifacts in full frame animations transferred to NTSC interlaced video

(76) Inventors: Michael H. Chu, Santa Clara, CA (US); Jean-Yves Bouguet, Milpitas, CA (US); Radek Grzeszczuk, Mountain View, CA (US)

Correspondence Address: KENYON & KENYON, 333 W. San Carlos, Street, Suite 600, San Jose, CA, 95110-2711, US

(21) Appl. No.: 09/895,768

(22) Filed: Jun. 29, 2001

(51) Int. Cl. G09G 5/00

(52) U.S. Cl. 345/611

(57) ABSTRACT

The present invention describes a procedure designed to reduce artifacts full-frame animations are taken and converted for use on an interlaced display (such as NTSC televisions). Each frame of animation is rendered at four times video resolution (1440×960 for video at 720×480) and twice temporal resolution (120 frames per second). Each frame is then resized with bicubic interpolation to 720×480 to produce smooth antialiased frames. Every pair of frames is then frame blended together to form one frame with motion blur. A gaussian blur of 0.2 pixel radius is applied to each frame and, finally, odd fields from each odd frame are interlaced with even fields from each even frame. The resulting video is smooth with minimal aliasing artifacts.

### FIELD OF THE INVENTION

The field of the present invention is that of image processing, and more specifically, the field of conversion of fill frame animation into video with interlaced fields.

### BACKGROUND OF THE INVENTION

In conventional video/image processing software, procedures designed to reduce artifacts when taking full-frame animations and converting them so that they may be used on an interlaced display (such as NTSC televisions). Because NTSC video is interlaced, many computer generated animations appear to flicker when they are displayed on television. Also, motion shown in interlaced video that has been converted from full frame animation tends to be discrete and unrealistic due to aliasing effects. There are many ways to reduce this flickering effect and present smooth, presentable television graphics. The method described in the present invention herein was invented as one way to minimize the artifacts introduced when converting full-frame animation to interlaced video such as NTSC video.

### BRIEF DESCRIPTION OF THE DRAWINGS

FIG. 1 illustrates a flowchart of the method embodied by the present invention.

### DESCRIPTION OF THE INVENTION

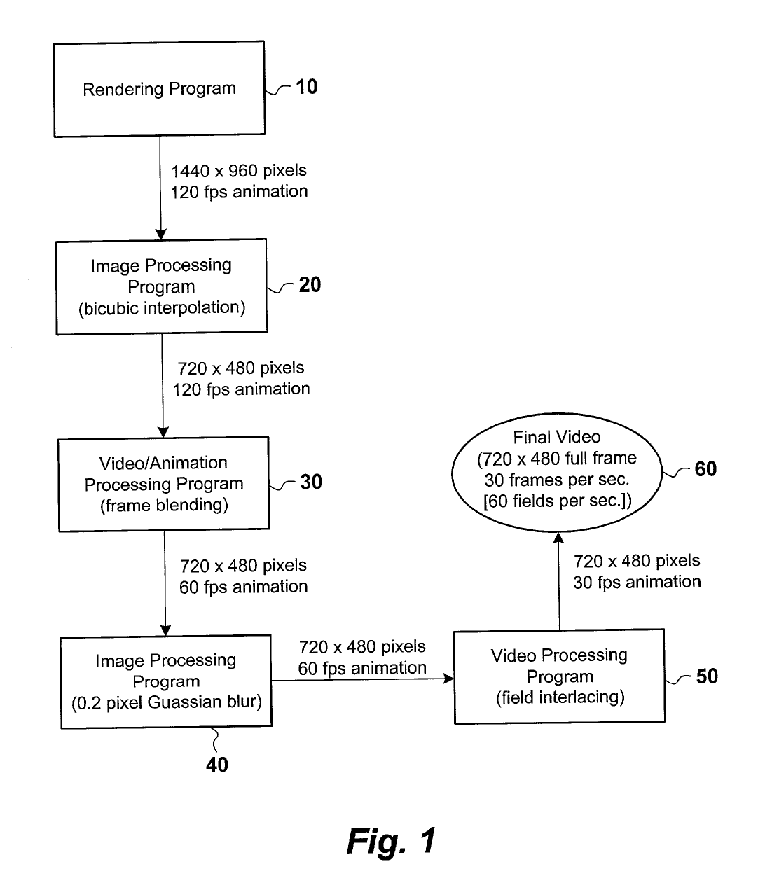

FIG. 1 is a flow chart of the process by which high-quality animation for interlaced video is produced from full frame animation which typically is displayed on a computer screen. Each frame of animation is “rendered” (or produced) at four times video resolution. The frames may be rendered at other whole number multiples of a digital video resolution value. The rendering step 10 is shown in FIG. 1. Four times video resolution at 720×480 DV is 1440×960.

The animated full frames are also rendered at twice the temporal resolution. Twice a typical temporal resolution for animation (60 frames per second), is 120 frames per second. Each full frame is then resized with bicubic interpolation to 720×480 pixel per frame in order to produce smooth, anti-aliased frames. The step of performing bicubic interpolation is shown in step 20. Bicubic interpolation is a method of translating the colors and characteristics of a pixel from an original image to a target image by using weighted values of pixels in the original image lying along a Bezier curve. Bezier curves possess properties that allow smoothly-joined target pixels to be drawn when the curves are used to locate pixels that will be used to calculate the position of the target pixel. Many drawing programs use Bezier cubic curves, which may be defined by the following parametric equations:

X(t)=eₓt³+fₓt²+gₓt+h₁

Y(t)=e_{y}t³+f_{y}t²+g_{y}t+i₁

first endpoint is given by P₁=(h₁, i₁). The second endpoint is given by P₄=(h₄,i₄)=(h₁+gₓ+fₓ+eₓi₁+g_{y}+f_{y}+e_{y}). The two remaining points which define the Bezier curve may be defined as follows: P₂=(h₂, i₂)=(h₁+gₓ/3, i₁+gx/3), P₃=(h₃, i₃)=(h₂+(gₓ+fₓ)/3, i₂+(g_{y} +f_{y})/3). The Bezier curves are defined by the intersections of three lines at the four points P₁-P₄.

Bicubic interpolation involves “averaging” the position of each pixel lying along the Bezier curve. For example, when AfterEffects is used to perform bicubic interpolation, a Bezier pen allows control points to be added to a graph. This graph shows how various characteristics of an object may be changed (such as the angle, size or location). Every pair of frames is then frame blended together to form one frame, producing a “motion blur” effect. This step is depicted in the block labeled 30. Because images that are close temporally are combined, any motion between frames is combined and blurred together when add the frames together. Many graphics applications including frame blending capability may be used to implement motion blurring. The principle is to simply take the average value of each pixel of two frames to form one frame.

A gaussian blur of 0.2 pixel radius is then applied to each frame. Gaussian blurring typically is performed after motion blurring. Gaussian blurring is a method of blurring adjacent pixels that involves weighing the color of each pixel based upon weighting factors located along a gaussian distribution.

Gaussian blurring involves blurring the colors and images depicted in pixels that are within a gaussian blur radius value of a designated center pixel. The number of pixels included in the gaussian blur process is proportional to a gaussian blur radius measured the center of a designated center pixel. Typically, a gaussian blur radius between 0.2 and 1.0 effectively removes the effects of aliasing. A larger gaussian blur radius will produce a more pronounced effect. The weights that are multiplied by each pixel are contained in a so-called “convolution mask.” In a “discrete” convolution mask, each pixel may be weighted by an identical amount so that each pixel to which the mask is applied is weighted evenly. However, in a gaussian convolution mask, weights decline gradually in a way that mimics the elevations of a gaussian distribution at various points. The “center” pixel of the group of pixels that form the mask is given the highest weight which corresponds to the middle of a gaussian distribution. Samples are taken from the gaussian distribution in order to fill the finite number of spaces in the mask. Pixels on the periphery of the group of pixels to which the mask is applied are given weights that correspond to the edges of the mask. This step is shown in block 40 of FIG. 1. Afterwards, odd fields from each odd frame are interlaced with even fields from each even frame, forming the final interlaced video frames (such as NTSC video) which are displayed at 30 frames per second (60 fields per second). The resulting video is smooth with minimal aliasing artifacts. The field interlacing step is shown as step 50 and the step involving the display of video is shown as step 60.

This method is advantageous because it is straightforward to implement with commercial software currently available and produces high quality video.

This technique has already been used in the production of Siggraph Paper Video entitled “Light Field Mapping: Efficient Compression and Interactive Rendering of Surface Light Fields,” but the present invention was by no means described therein. By using this method, Intel was able to produce smooth video from a rendering program designed by Intel. Full frame video animation produced by a rendering program used in the present invention would not be smooth without this technique. This method will continue to be used in future Intel video productions relating to computer animation.

The present invention has many applications beyond the primary embodiment discussed above. The invention may be used in the context of the creation of stop motion animation or “claymation” images. Stop motion animation is a method of animation that involves taking a picture of a scene, moving a camera, taking a second picture, moving the camera a second time, and so forth. The process described in the previous sentence is repeated until a particular scene is completed. At the moment each photograph or image is captured, no movement occurs—both the camera and the objects are stationary. Between frames, both can be moved, but when a photograph is taken, everything is static again. Thus no motion occurs during a photograph. If played back fast enough, an individual's concludes that objects in photographs are moving but the motion individuals' detect is not smooth because the object are in fact stationary and an individual's eyes typically detect physical clues of a lack of continuous motion.

The present invention may also be able to be used with a motion blur process that that blends previously blended frames with a subsequent frame that was not blended. For instance, if frames A, B, C, and D were to be blended, frames A and B would be blended together, then frames B and C would be blended together, and then frames C and D would be blended together to create three blended frames from four.

However, the number of frames displayed per second in a stop motion animation film may be reduced from 120 frames per second to 60 frames per second. If the frame rate of a stop motion animation film is reduced in this manner, an effect may be created that simulates motion blur when applied to full frame video.

While certain embodiments of the present invention have been described herein, the present invention should not be construed as being restricted to those embodiments. All embodiments and implementations covered by the claims as amended will be embraced by the present invention.

While certain embodiments of the present invention have been described herein, the present invention should not be construed as being restricted to those embodiments. All embodiments and implementations covered by the claims as amended will be embraced by the present invention.

1. A method of converting animation into video with interlaced fields, the method comprising:
Rendering of full frames at a whole number multiple of a digital video resolution value defining the number of pixels contained in each frame and at a whole number multiple of a temporal resolution value defining the rate of display of full frames on a computer screen;
Resizing each full frame to produce a plurality of frames that are antialiased;
Blending each consecutive frame.

2. A method of converting animation into video with interlaced fields, the method comprising:
Rendering of full frames at a whole number multiple of a digital video resolution value defining the number of pixels contained in each frame and at a whole number multiple of a temporal resolution value defining the rate of display of full frames on a computer screen;
Resizing each full frame to produce a plurality of frames that are antialiased;
Blending each consecutive frame;
Blending the colors and images depicted in pixels that are within a gaussian blur radius value of a center pixel, wherein the number of pixels blended is proportional to a gaussian blur radius;
Separating each frame into a first and second field, wherein the first field contains the even lines of a frame and the second field contains the odd lines of a frame;
Alternately displaying the first and second fields of each frame, the first field of each frame with the second field of each frame.

3. The method of claim 1, wherein blending the colors and images depicted in pixels that are within a gaussian blur radius value of a center pixel is performed, wherein the number of pixels blended is proportional to a gaussian blur radius.

4. The method of claim 1, wherein separating each frame into a first and second field, the first field contains the even lines of a frame and the second field contains the odd lines of a frame.

5. The method of claim 1, wherein alternately displaying the first and second fields of each frame, the first field of each frame with the second field of each frame.

6. The method of claim 1, wherein resizing each full frame to produce antialiased frames is performed with bicubic interpolation.

7. The method of claim 1, wherein each pair of consecutive frames is blended by averaging corresponding pixel values of each frame.

8. The method of claim 1, wherein gaussian blurring of a non-zero pixel radius is performed that blends the colors and images depicted in pixels that are within a gaussian blur radius value of a center pixel.

9. The method of claim 2, wherein resizing each full frame to produce antialiased frames is performed with bicubic interpolation.

10. The method of claim 2, wherein each pair of consecutive frames is blended by averaging corresponding pixel values of each frame.

11. The method of claim 2, wherein gaussian blurring of a non-zero pixel radius is performed that blends the colors and images depicted in pixels that are within a gaussian blur radius value of a center pixel.

12. The method of claim 3, wherein the gaussian blur pixel radius is 0.2.

13. The method of claim 3, wherein the gaussian blur pixel radius is greater than 0.2.

14. The method of claim 3, wherein the gaussian blur pixel radius is less than 0.2.

15. The method of claim 1, wherein said rendering step is implemented using “Photoshop” software.

16. The method of claim 1, wherein said separating step is implemented using “After Effects” software.

17. The method of claim 1, wherein said animation consists of film displayed at the rate of at least 24 frames per second.

18. The method of claim 1, wherein said rendering step is performed with “Renderman” software.

19. A video conversion system, the system comprising:
A computer terminal defining the number of pixels contained in each frame of full frames that are rendered at a whole number multiple of a digital video resolution value and that are rendered at a whole number multiple of a temporal resolution value defining the rate of display of full frames;
A computer screen attached to said terminal.

20. The system of claim 19, wherein each full frame is resized to produce antialiased frames.

21. The system of claim 20, wherein the colors and images depicted in pixels located at identically numbered pixel points in each frame are blended together.

22. The system of claim 21, wherein each frame is separated into a first and second field.

23. The system of claim 22, wherein the first field contains the even lines of a frame and the second field contains the odd lines of a frame.

24. The system of claim 23, wherein the first and second fields of each frame are interlaced and displayed alternately.

25. The system of claim 24, wherein each full frame is resized to produce antialiased frames using bicubic interpolation.

26. The system of claim 25, wherein each pair of consecutive frames is blended by averaging corresponding pixel values of each frame.

27. The system of claim 26, wherein gaussian blurring is performed that blends the colors and images depicted in pixels that are in proximity to one another in each frame.

28. The system of claim 27, wherein the gaussian blur pixel radius is 0.2.

29. The system of claim 28, wherein the gaussian blur pixel radius is greater than 0.2.
